(19) United States
(12) Patent Application Publication
(10) Pub. No.: US 2007/0033786 A1
(43) Pub. Date: Feb. 15, 2007

(54) Milling machine turning systems and methods

(76) Inventor: George A. Bradley, Carlsbad, CA (US)

Correspondence Address: FISH & RICHARDSON, PC, P.O. BOX 1022, MINNEAPOLIS, MN, 55440-1022, US

(21) Appl. No.: 11/501,461

(22) Filed: Aug. 8, 2006

Related U.S. Application Data
(60) Provisional application No. 60/706,802, filed on Aug. 9, 2005.
(60) Provisional application No. 60/775,446, filed on Feb. 21, 2006.

(51) Int. Cl. B23P 13/04

(52) U.S. Cl. 29/27 C; 29/50; 29/557

(57) ABSTRACT

A milling machine system includes a tooling platform, a cutting too spindle, an automated control system including code for controlling operation of a milling machine to perform milling operations, and software that converts the code for controlling operation of a milling machine to perform milling operations into code for controlling operation of a milling machine to perform one or more turning operations. The tooling platform includes one or more tools extending horizontally from the tooling platform and one or more tools extending vertically from the tooling platform. The cutting tool spindle rotates about an axis of rotation, wherein the spindle includes a securing means adapted to secure a piece of material to be machined in an orientation along the axis of rotation of the spindle.

### REFERENCE TO PRIORITY DOCUMENT

This application claims priority of U.S. Provisional Patent Application Ser. No. 60/706,802 entitled “Milling Machine Turning System and Manufacturing Method”, filed Aug. 9, 2005 and U.S. Provisional Patent Application Ser. No. 60/775,446 entitled “Milling Machine Turning Systems and Methods”, filed Feb. 21, 2006. Priority of the aforementioned filing dates is hereby claimed, and the disclosures of the Provisional Patent Applications are hereby incorporated by reference.

### BACKGROUND

The present disclosure relates generally to milling machines and lathes. More specifically, the present disclosure relates to a tooling system and method for converting a milling machine into a machine capable of performing turning operations typically done on a lathe.

The lathe and the milling machine are basic to the art of machining. The lathe is designed to rotate material clamped in a spindle while a non-rotating cutting tool, fixed to a slide, removes some of the material. In the case of a milling machine, the material does not rotate but is fixed to the slide or table while the cutting tool rotates in the spindle to remove some of the material. As a result, the lathe produces basically round shapes while the milling machine can mill, drill, ream, tap, etc.

Currently, it is the common practice to perform turning operations on a lathe and leave the various other machining operations to be performed by milling machines. Accordingly, good machine shops typically have lathes and milling machines in order to be able to handle all types of machining operations. There are many instances when a shop may have an abundance of lathe work and are low on millwork and vice versa. Yet, because automated lathes and milling machines are so expensive, it may not be economically feasible to purchase another lathe, for example, to keep up with demand. Moreover, it is of extreme importance for a manufacturer or machine shop to keep their machine tools running at capacity at all times. Therefore, the applicant has discovered that the ability to quickly convert a milling machine to perform work that the overburdened lathe department cannot handle would be of immense value.

Various machines that perform both milling and turning operations are known. The principal advantage of these machines is that the workpieces can remain on the same table and in one setting for different milling and turning operations. The main disadvantage of these machines is that they require the purchase of complex gear driven or motorized accessories that are attached to a milling machine structure. These attachments tend to be cumbersome and take up much of the working envelope of the machine tool. Furthermore, they only allow small components to be machined and are limited in their use. U.S. Pat. Nos. 5,301,405 and 5,586,382 provide examples of such machines.

In recent years, automatic lathes have been developed for machining of much more complex workpieces from a bar-shaped work material. For example, compound or combination machining has been developed, where a large number of types of tools are provided on a tool rest to enable diverse automatic machining, including the performance of milling functions. Further, to shorten the machining time, various multifunction type automatic lathes carrying a plurality of spindles and a plurality of tool rests close together on a single lathe bed have been proposed. These lathes are capable of performing different types of machining simultaneously on the same bar or simultaneous machining on different bars. These options, however, are expensive and such lathes are typically limited in the size of the area in which any milling functions can be performed. Moreover, there are few options to do three-axis milling on a lathe that is converted to perform milling functions. In addition, reprogramming lathes to perform the functions of a milling machine can be a lengthy, difficult, and expensive process.

Therefore, it would be highly desirable to be able to use a milling machine for turning functions. Moreover, it would be highly desirable to be able to easily, quickly, and cheaply perform both milling and turning operations on a milling machine. It would also be highly desirable to perform turning operation on a milling machine platform.

### SUMMARY

In accordance with one embodiment, there is provided a milling machine system that includes a tooling platform, a cutting too spindle, an automated control system including code for controlling operation of a milling machine to perform milling operations, and software that converts the code for controlling operation of a milling machine to perform milling operations into code for controlling operation of a milling machine to perform one or more turning operations. The tooling platform includes one or more tools extending horizontally from the tooling platform and one or more tools extending vertically from the tooling platform. The cutting tool spindle rotates about an axis of rotation, wherein the spindle includes a securing means adapted to secure a piece of material to be machined in an orientation along the axis of rotation of the spindle.

In accordance with another embodiment, there is provided a milling machine system that includes a cutting tool spindle that rotates about an axis of rotation, a rotary tooling platform, an automated control system with code for controlling operation of the milling machine to perform milling operations, and software that converts the code for controlling operation of a milling machine to perform milling operations into code for controlling operation of a milling machine to perform one or more turning operations. The rotary tooling platform includes a rotary cylinder that rotates about an axis of rotation that is substantially perpendicular to the axis of rotation of the cutting tool spindle of the milling machine. The rotary cylinder includes a cylindrical base and a first set of tools that extend radially outward from the base and a second set of tools that extend in a direction substantially parallel to the axis of rotation of the rotary tool cylinder. The cutting tool spindle has securing means adapted to secure a piece of material to be machined along the axis of rotation of the spindle. The cutting tool spindle can rotate about a vertical axis, a horizontal axis, or a hybrid axis.

In accordance with another embodiment, a machining tool includes a tombstone mounting fixture and a rotary tooling platform. The tombstone mounting fixture rotates about a first axis of rotation and has a top surface. The rotary tooling platform includes a cylindrical base that rotates about a second axis of rotation. The rotary tooling platform has a first set of tools that extend radially outward from the base and a second set of tools that extend in a direction substantially parallel to the axis of rotation of the base. The rotary tooling platform is mounted on the top surface of the tombstone mounting fixture, and the second axis of rotation is substantially parallel to the first axis of rotation.

In accordance with another embodiment, a milling machine system includes a cutting tool spindle, a tombstone mounting fixture, a rotary tooling platform, an automated control system comprising code for controlling operation of the milling machine system to perform milling operations, and software that converts the code for controlling operation of a milling machine system to perform milling operations into code for controlling operation of a milling machine system to perform one or more turning operations. The spindle rotates about a first axis of rotation and includes a securing means adapted to secure a piece of material to be machined in an orientation along the first axis of rotation of the spindle. The tombstone mounting fixture rotates about a second axis of rotation and has a top surface. The rotary tooling platform includes a cylindrical base that rotates about a third axis of rotation. The rotary tooling platform has a first set of tools that extend radially outward from the base and a second set of tools that extend in a direction substantially parallel to the axis of rotation of the base. The rotary tooling platform is mounted on the top surface of the tombstone mounting fixture, and the third axis of rotation is substantially parallel to the second axis of rotation.

In accordance with another embodiment, there is provided a method for turning an unfinished piece of material. The method includes providing a milling machine with a cutting tool spindle that rotates about an axis of rotation and a work platform that has one or more working tools. The position and orientation of the work platform in relation to the position and orientation of the spindle can be changed using an automated control system. The method also includes securing the piece of material to the cutting tool spindle of the milling machine so that the material is secured in a vertical orientation along the axis of rotation of the spindle. The method further includes rotating the spindle thereby spinning the material about the axis of rotation, and bringing one or more of the working tools into contact with the material, thereby removing a portion of the material.

### BRIEF DESCRIPTION OF THE DRAWINGS

FIG. 1 is a perspective view of one embodiment of a milling machine system that performs both milling and turning operations.

FIG. 2 is a side view of the milling machine system depicted in FIG. 1.

FIG. 3 is a detailed perspective view of a tooling block of a milling machine system in accordance with one embodiment.

FIG. 4 is a perspective view of another embodiment of a milling machine system that performs both milling and turning operations.

FIG. 5 is a perspective of another embodiment of a milling machine system that performs both milling and turning operations.

FIG. 6 is a detailed perspective view of a rotary tool turret of a milling machine system in accordance with one embodiment.

FIG. 7 is a side view of another embodiment of a milling machine system that performs both milling and turning operations.

FIG. 8 is a top view of the milling machine system depicted in FIG. 7.

FIG. 9 is a perspective view of a machining tool.

### DETAILED DESCRIPTION

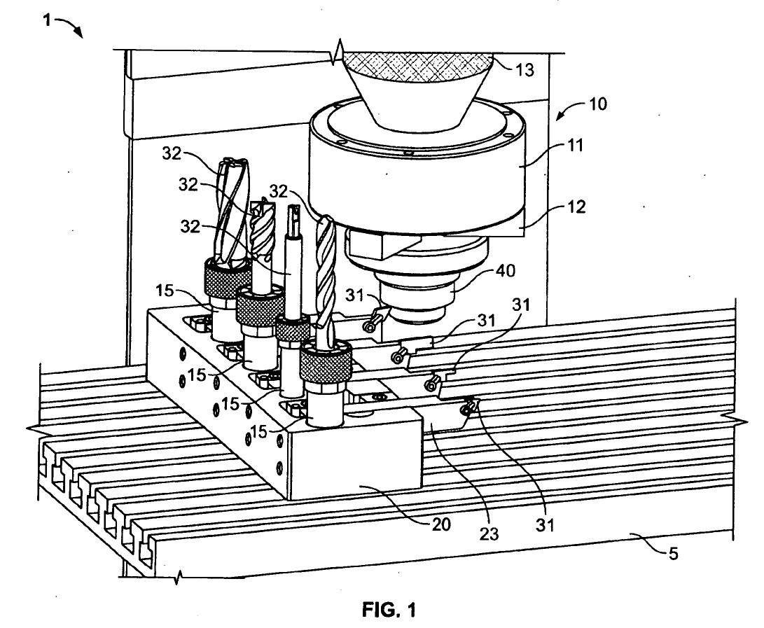

FIG. 1 provides a perspective view of one embodiment of a milling machining system 1 that performs both milling and turning operations. The system 1 can be assembled off of any milling machine platform known to those of skill in the art, including any CNC milling machine.

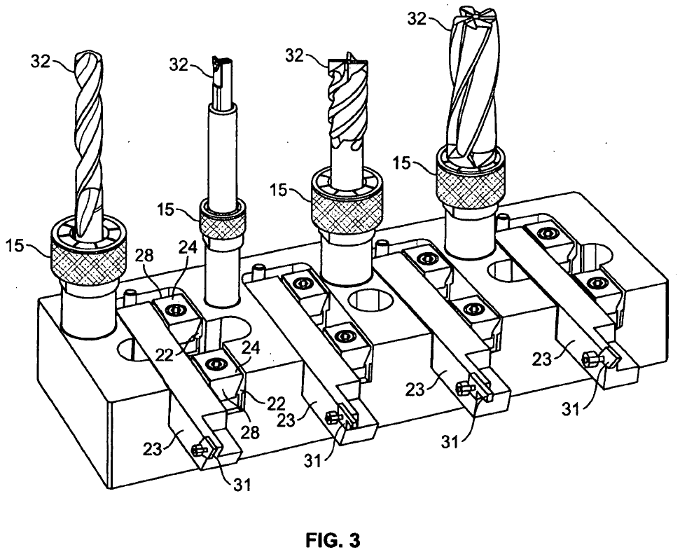

The tooling block 20 includes a number of horizontally arranged insert holders 23, which are mounted on the tooling block 20. The insert holders 23 can be cutting tool holders that hold, for example, outside diameter (“OD”) tools 31 or inside diameter (“ID”) tools 32. The insert holders 23 depicted in FIG. 1 are holding four OD tools 31. The tooling block 20 can have as few as 1 or as many as 20 or more insert holders 23 holding as many tools. The insert holders 23 are secured to the tooling block 20 using clamps. As shown in FIG. 3, one or more clamp extrusions 22 and wedges 24 can be combined to form the clamps 28 used to secure the insert holders 23. In the embodiment shown in FIG. 1, each insert holder 23 is secured by two clamps 28, and each clamp is formed by a clamp extrusion 22 and wedge 24. Other means of securing the insert holders 23 to the tooling block 20 can also be used. In addition, the insert holders 23 may be formed of a unibody construction integral with the tooling block 20. The OD cutting tools 31 shown in FIG. 1 are commonly used to perform such turning operations as rough turning, finish turning, profiling, grooving, threading, and parting-off.

The tooling block 20 also includes one or more vertically oriented tools such as those shown in FIG. 1 mounted on the tooling block 20. The vertically oriented tools can be held in place using one or more vertically oriented collet chucks 15. The collet chucks 15 can hold, for example, OD tools 31 or ID tools 32. The tools extend vertically upward from the collet chucks 15, of which there are four depicted in FIG. 1. The vertically oriented tools shown in FIG. 1 are ID tools 32. The tooling block 20 can have as few as 1 or as many as 20 or more collet chucks 15 for securing as many vertically oriented tools. The ID tools 32 can include, for example, a drill, a center drill, a boring bar, and a threading tool, any of which can be used for ID turning operations in a common machining setup.

In addition, one or more of the tools shown in FIG. 1 can be live rotary tools, such as an air or electric spindle. Such live rotary tools can be added to one of the tooling fixtures (collet chucks 15 or insert holders 23 in the tooling block 20) to allow for milling operations to be performed on the turned part being rotated or held firmly in chuck 11.

The tooling block 20 is properly located and firmly anchored to a milling machine table 5 prior to use. As an option, the tooling block 20 can also include one or more riser blocks (not shown). Riser blocks are used to offset the height of the tooling block 20 from the milling machine table 5 to allow for a longer part to be machined. As few as one or as many as twenty or more riser blocks can be used to prop up the tooling block 20. The riser blocks can be between one and six inches tall, and as many riser blocks as needed can be stacked atop each other and secured to the bottom of the tooling block 20.

The milling machine conversion system 1 also includes a spindle assembly 10. The spindle assembly 10 is generally assembled to a milling machine. In use, the spindle assembly 10 is positioned above the tooling block 20. The spindle assembly 10 includes a milling machine spindle 13 (part of the milling machine), a chuck 11 with chuck jaws 12 that holds the part 40 or piece that is to be machined. The chuck 11 has a matching interface with the milling machine spindle 13. This configuration allows the chuck 11 to be easily and firmly connected to the milling machine spindle 13. In a typical milling machine, a tool is attached to the spindle and is used to cut, bore, or otherwise machine a part that is secured to the milling machine table. In the present embodiment, chuck 11 is configured to hold a part 40, material, or piece that is rotated (turned) against one or more of the tools secured to the tooling block 20 positioned below the spindle assembly 10. In addition, chuck 11 can be replaced with a collet chuck 15 to hold smaller diameter materials. The chuck 11 can also be replaced with a tooling faceplate to allow for larger diameter or odd shaped work pieces to be held in the milling machine spindle 13.

As explained above, the tooling block 20 has been depicted with four horizontal OD tools 31 and four vertical ID tools 32. The tool block 20 could, however, be larger to accommodate a greater number of tools if space within the milling machine would allow. Likewise, the tooling block 20 could be smaller to accommodate fewer tools and a smaller work area or a different manufacturing need.

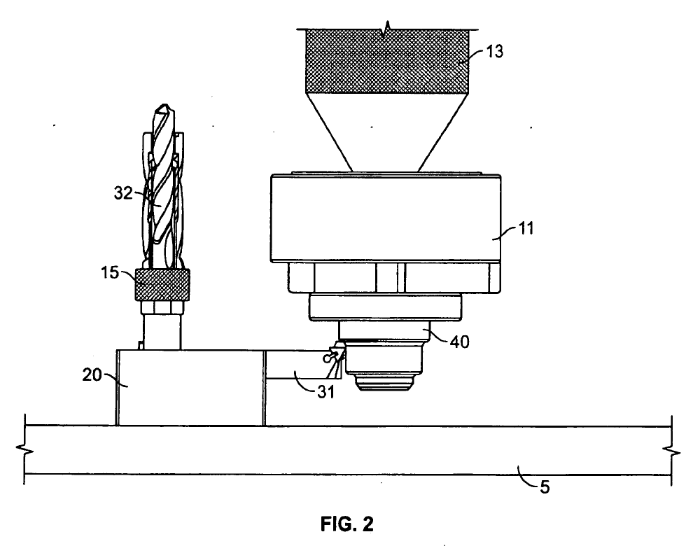

As shown in FIG. 2, the part 40 is loaded into the chuck 11 for a turning operation. An OD tool 31 is brought into contact with the part 40 while the part 40 is spinning. In a vertical milling machine (as shown in FIGS. 1-3), the spindle 13 can be lowered and raised along the vertical or Z axis in order to make contact between the part 40 and the tool 31. Alternatively, the milling machine table 5 may be raised or lowered along the vertical or Z axis. The part 40 can also be moved along the X and Y axes relative to the tooling block 20 so that it can make contact with the ID tools 32. In order to achieve contact between the ID tools 32 and the part 40, the spindle can be moved in the X and/or Y directions so that the part is positioned appropriately above the desired tool. The spindle 13 can then be lowered in the Z direction until the ID tool 32 is in working contact with the part 40. Alternatively, the spindle 13 can remain stationary, while the milling machine table 5 moves in the X and/or Y and Z directions relative to the spindle 13.

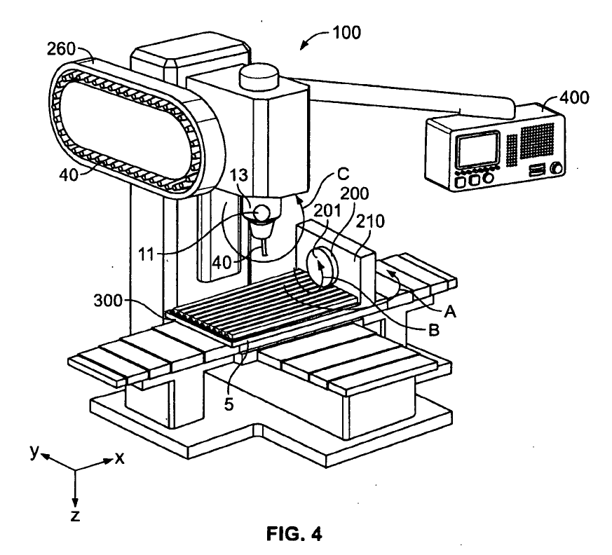

FIGS. 4-6 show another embodiment of a milling machine system 100. Like system 1, system 100 can be assembled off of any milling machine platform known to those of skill in the art, including any CNC milling machine. The system 100 includes an automatic tool changer 260 that is loaded with parts 40 rather than tools. For example, the automatic tool changer 260 can be loaded with a plurality of slugs 40. Once a slug 40 that is loaded into the spindle 13 is machined, that slug is removed and a new one is automatically retrieved from the automatic tool changer 260 and coupled to the spindle 13 for machining. The system 100 allows for continuous and automatic turning of parts 40 on a milling machine.

The system 100 also includes a cylindrical tooling fixture 200 as opposed to the linear block configuration shown in FIGS. 1-3. This cylindrical tooling fixture 200 can be mounted on a rotary table post 210 allowing the tools attached to the cylindrical tooling fixture 200 to be rotated about axis B into different positions. The different tools on the cylindrical tooling fixture 200 can be positioned appropriately in relation to the milling machine spindle 13 allowing for different types of cutting tools to be used, more tools to be held at once, or tools to be held at angles otherwise not easily fixed. The cylindrical tooling fixture 200 can rotate about an axis of rotation—axis B—that is substantially perpendicular to the axis of rotation—axis B—of the cutting tool spindle 13 of the milling machine.

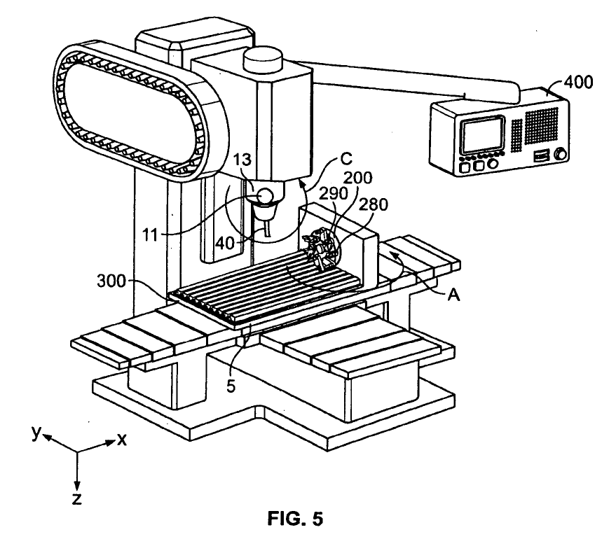

As shown in FIG. 5 the cylindrical tooling fixture 200 can be a rotary tool turret formed by a cylindrical base 201 and a plurality of tools extending in various directions from the base 201. The rotary tool turret 200 can have a first set of tools 280 that extend radially outward from the cylindrical base 201 and a second set of tools 290 that extend in a direction substantially parallel to the axis of rotation of the rotary tool turret or perpendicular to the cylindrical base 201. In one embodiment, tools 280 extending radially outward are turning tools or OD tools, such as boring and threading tools, while tools 290 are ID tools or drilling tools. In another embodiment, tools 280 are ID tools or drilling tools, while tools 290 are turning tools or OD tools. In addition, one or more of the ID or drilling tools can be live rotary tools, such as an air or electric spindle added to one of the tooling fixtures to allow for milling operations to be performed on the part 40 being rotated or held firmly in chuck 11.

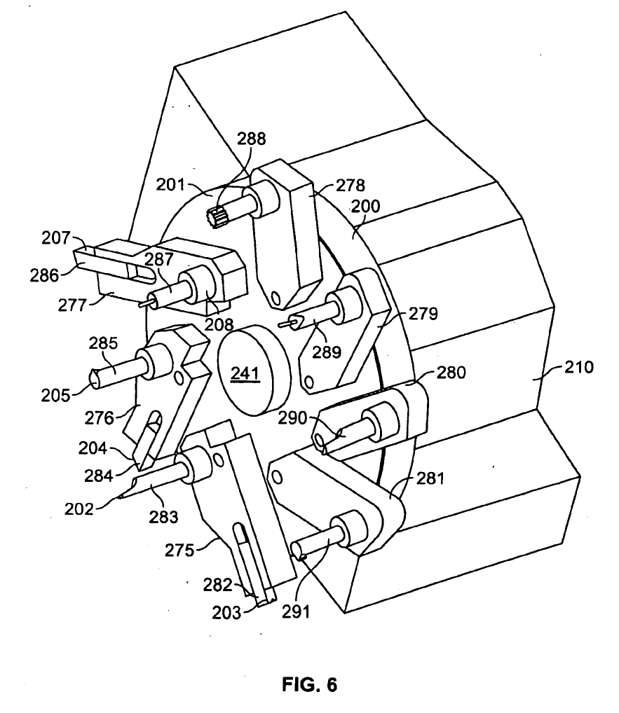

FIG. 6 provides a detailed view of one example of a rotary tool turret 200 that can be used in the milling machine system 100. The turret 200 can be rotatably bolted to the rotary table post 210 with a bolt 241 running through the center of the turret 200. The turret 200 includes tooling blocks 275-281. As illustrated in FIG. 6, the tool blocks 278-281 can accept inside diameter tools 288-291, while the tool blocks 275-277 can be combination tool blocks that can accommodate turning tools 282, 284, and 286 at stations 203, 204 and 207 respectively, and inside diameter tools 283, 285, and 287at stations 202, 205 and 208 respectively. Alternatively, all of the tooling blocks 275-281 can be combination tool blocks that can accommodate turning tools and inside diameter tools. In addition, any of the ID tools 288-291 can be live rotary tools.

A method of turning an unfinished part or piece of material in accordance with the embodiments shown in FIGS. 1 and 2 involves the following steps. First, the operator or a preprogrammed automated system chooses the cutting tools necessary to perform the needed machining operation. Next, these tools are firmly located in proper positions in the tooling block 20 or cylindrical tooling fixture 200. They are placed in the insert holders 23 or the collet chucks 15 of the tooling block 20 or the tool insert locations on the cylindrical tooling fixture 200. Next, the appropriate chuck jaws 12 and chuck 11 are firmly coupled to the spindle 13. Next, the machining material is firmly secured to chuck 11 so that the material is secured in a vertical orientation along the axis of rotation of the spindle (designed by reference C in FIG. 2). The spindle 13 is then activated, thus rotating the material about the spindle's axis of rotation C at an appropriate speed (RPM) to perform the machining operation. The tooling block 20 or the cylindrical tooling fixture 200 with all of its necessary cutting tools is positioned, either manually or with the aid of a computer aided control system, into the proper cutting positions beneath the spindle 13. The relative movement of the tooling block 20 or the cylindrical tooling fixture 200 in relation to the spindle 13 can be accomplished by moving the spindle 13, by moving the tooling block 20 or the cylindrical tooling fixture 200, or by moving both the spindle 13 and the tooling block 20 or cylindrical tooling fixture 200. The spindle 13 can be moved in the x, y or z directions as shown in FIG. 2. The tooling block 20 can be moved by moving the milling machine table 300 onto which the tooling block 20 is mounted in either the x, y or z directions as shown in FIG. 2. The cylindrical tooling fixture 200 can be moved by rotating the cylinder about its axis of rotation B into the proper tool position and also by moving the base 201 of the rotary cylinder in the x, y or z directions as shown in FIG. 2. Finally, the needed machining steps are performed to complete the machining operation thereby removing a portion of material from the material or piece being machined. These machining steps are performed either manually or by a computer aided control system 400 controlling the milling machine, such as in the case of a Computer Numerical Control (“CNC”) milling machine.

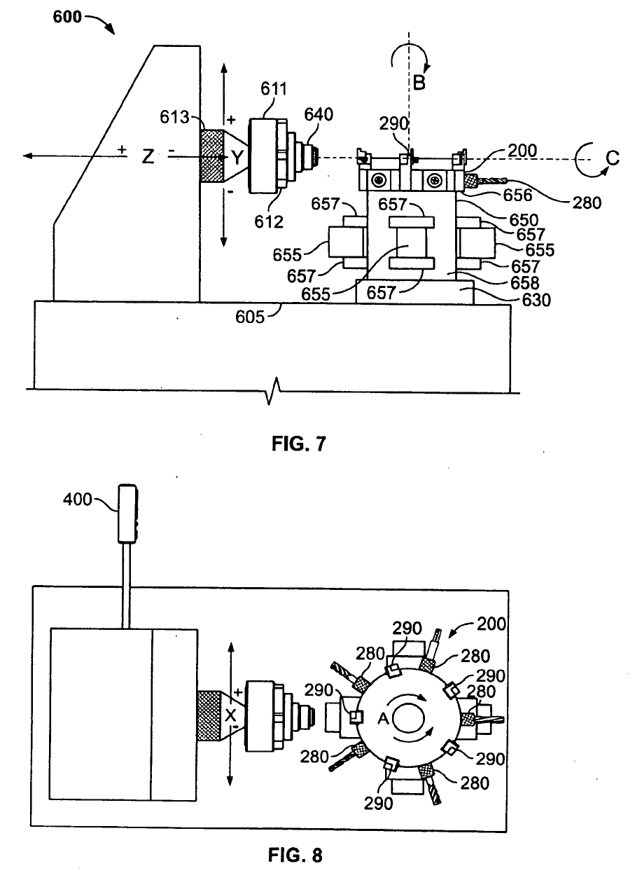

In another embodiment, as shown in FIGS. 7-8, a system 600 for a horizontal milling machine is shown. The system 600 can be assembled off of any milling machine platform known to those of skill in the art, including any CNC milling machine. The system 600 includes a horizontal milling machine with a spindle 613 connected to a chuck 611 with chuck jaws 612. The system 600 also includes a computer aided control system 400 controlling the milling machine, such as in the case of a Computer Numerical Control (“CNC”) milling machine. Typically, a tool would be inserted into the jaws 612 of the chuck 611 to perform a milling operation on a part. Instead, a lathe part 640 is loaded onto the chuck 611 and turned.

The milling machine includes a table or platform 605 that carries a rotary table 630. A tombstone mounting fixture 650 is mounted on the rotary table 630. The tombstone mounting fixture 650 can be loaded with milling block parts 655, which are held in place with vises 657 in a manner generally known in the art. As shown in FIG. 7, the tombstone has four vertical faces 658, each of which carries a set of vices that holds a milling block part 655 securely on the tombstone. Tombstones with greater or fewer faces can also be used.

As shown in FIGS. 7 and 8, the tombstone mounting fixture 650 has a rotary tool turret 200 mounted on its top horizontal surface 656. The turret 200 includes a cylindrical base 201 and a plurality of tools extending along various vectors from the base 201. The cylindrical base 201 of the rotary tool turret 200 can be rotatably bolted to the top surface 656 of the tombstone mounting fixture 650 with a bolt 241 running through the center of the turret 200. The turret 200 is rotatably mounted atop the tombstone 650 so that the turret 200 can be rotated about its axis B. The axis of rotation of the turret 200 is the same as or parallel to the axis of rotation of the rotary table 630. The turret 200 is rotatable independently from the tombstone 650 and the rotary table 630, so that the turret 200 can rotate about its axis B while the tombstone 650 and rotary table 630 remain radially stationary.

The turret 200 can be similar to the turret 200 shown in the previous figures. The rotary tool turret 200 can have a first set of tools that extend radially outward 280 from the cylindrical base 201 and a second set of tools 290 that extend in a direction substantially parallel to the axis of rotation of the rotary tool turret 200 or perpendicular to the cylindrical base 201. In one embodiment, tools 280 extending radially outward are turning tools or OD tools, such as boring and threading tools, while tools 290 are ID tools or drilling tools. In another embodiment, tools 280 are ID tools or drilling tools, while tools 290 are turning tools or OD tools. In addition, one or more of the ID or drilling tools can be live rotary tools, such as an air or electric spindle added to one of the tooling fixtures to allow for milling operations to be performed on the part 640 being rotated or held firmly in chuck 611.

The system 600 also includes a computer aided control system 400 controlling the milling machine, such as in the case of a Computer Numerical Control (“CNC”) milling machine.

In another embodiment, not shown, a tombstone is not included, and the tool turret 200 can be attached directly to the horizontal milling machine table 605 or to a platform attached to the horizontal milling machine table 605.

A method of turning an unfinished part or piece of material in accordance with the embodiments shown in FIGS. 7 and 8 involves the following steps. First, the operator or a preprogrammed automated system chooses the cutting tools necessary to perform the needed machining operation. Next, these tools are firmly located in proper positions in the tool turret 200. Next, the appropriate chuck jaws 612 and chuck 611 are firmly coupled to the spindle 613. Next, the machining material 640 is firmly secured to chuck 611 so that the material is secured in a horizontal orientation along the axis of rotation of the spindle. The spindle 613 is then activated, thus rotating the material 640 about the spindle's axis of rotation C at an appropriate speed (RPM) to perform the machining operation. The tombstone 650 and spindle 613 are moved in relation to one another so that the appropriate tools of the tool turret 200 can come into contact with the machining material or workpiece 640. This is accomplished either by moving the tombstone 650 in the X, Y, and/or Z directions, the spindle 613 in the X, Y, and/or Z directions, or both the spindle 613 and the tombstone 650 in the X, Y and/or Z directions. The tool turret 200 is rotated about its axis B until the appropriate tool is aligned with the workpiece 640. All of these movements can be accomplished manually or with the aid of a computer aided control system 400. The needed machining steps are performed to complete the machining operation thereby removing a portion of material from the workpiece 640. Finally, the workpiece 640 is removed from the chuck 611, and a milling tool is inserted in the chuck 611. The milling tool is then used to perform various milling operations on the milling block parts 655.

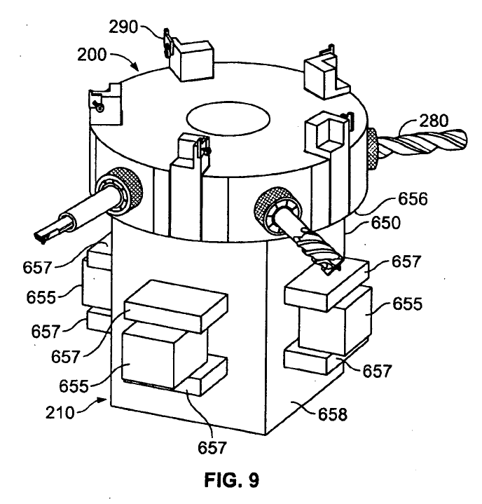

FIG. 9 is an illustration of the machining tool depicted in FIGS. 7 and 8. The machining tool includes a tombstone mounting fixture 650 and a rotary tool turret 200 coupled to the top of the tombstone mounting fixture 650. The tombstone mounting fixture 650 can be loaded with milling block parts 655, which are held in place with vises 657 in a manner generally known in the art. As shown in FIG. 7, the tombstone has four vertical faces 658, each of which carries a set of vices that holds a milling block part 655 securely on the tombstone. A tombstone mounting fixture with greater or fewer faces can also be used.

The tombstone mounting fixture 650 has a rotary tool turret 200 mounted on its top horizontal surface 656. The rotary tool turret 200 includes a cylindrical base 201 and a plurality of tools extending along various vectors from the base 201. The cylindrical base 201 of the rotary tool turret 200 can be rotatably bolted to the top surface of the tombstone mounting fixture 650 with a bolt 241 running through the center of the turret 200. The turret 200 is rotatably mounted atop the tombstone 650 on the top surface 656 of the tombstone 650 so that the turret 200 can be rotated about its axis B. The axis of rotation of the turret 200 is the same as or parallel to the axis of rotation of any rotary table on which the tombstone 650 may sit. The turret 200 is rotatable independent from the tombstone 650, so that the turret 200 can rotate about its axis B while the tombstone 650 can remain radially stationary or can rotate at a different speed or direction from the turret 200.

The rotary tool turret 200 can have a first set of tools that extend radially outward 280 from the cylindrical base 201 and a second set of tools 290 that extend in a direction substantially parallel to the axis of rotation of the rotary tool turret 200 or perpendicular to the cylindrical base 201. In one embodiment, tools 280 extending radially outward are turning tools or OD tools, such as boring and threading tools, while tools 290 are ID tools or drilling tools. In another embodiment, tools 280 are ID tools or drilling tools, while tools 290 are turning tools or OD tools. In addition, one or more of the ID or drilling tools can be live rotary tools, such as an air or electric spindle added to one of the tooling fixtures to allow for milling operations to be performed on the part 640 being rotated or held firmly in chuck 611.

The machining steps described above are performed either manually or by a computer aided control system 400 controlling the milling machine, such as in the case of a Computer Numerical Control (“CNC”) milling machine. For example, the computer aided control system 400 depicted in FIGS. 4 and 8, includes code for controlling the operation of an automated control system including code for controlling operation of the milling machine to perform milling operations. The computer aided control system 400 can further include software that converts the code for controlling operation of a milling machine to perform milling operations into code for controlling operation of a milling machine to perform one or more turning operations.

There are several ways in which a computer aided control system is typically programmed. A computer aided control system usually includes a keyed control pad, and one way to program the system to operate the milling machine is to hand program using the control pad. Alternatively, the control system can be programmed on a separate computer and imported to the computer aided control system.

Another way to program a milling machine is to use cad/cam software. An accurate image of the part to be machined is created in cad and imported to the cam software. Tool paths along the features of the cad image are then created. Once the tool path is created, the software asks the programmer for the type of machine control to which the code should be converted. This conversion code, or Post, is customized for each type of machine, such as Haas, Fadel, Mazak, and the like. The Post then takes the cad/cam toolpath and converts it to the proper language that the individual machine control needs to run the toolpath.

A third way in which a milling machine control system is programmed is by using conversational programming built in to the control system. A control system with conversation programming prompts the user, such as a machinist, to input the parameters of the shape to be cut. An example would be the length, diameter, location in X and Z of any grooves or threads or inside thread dimensions. The control system then builds the proper code to produce the proper toolpath.

With respect to the computer aided control system 400 presented herein, a custom Post may not exist. Therefore, in one embodiment, changes to the program can be made manually so that the milling machine can operate as a lathe.

In another embodiment, an automatic editor can be used to convert a cad/cam program posted for a lathe control into one that can be used by a mill control. For example, if a program is created in cad/cam and posted for a Haas milling machine control, it will currently post for a lathe control because a custom post does not exist to run lathe parts on a mill. Thus, without the custom post, the cad/cam Haas control posted lathe program can be run through the editor to convert it into one that the mill control can read.

In another embodiment, the milling machine can be built from the beginning to run milling operations but with a conversion feature that includes a machine control that has the functionality of a mill control and a lathe control. For instance, the milling machine includes software that includes custom posts to write code from a cad/cam software that requires no editing. This embodiment eliminates the need for an automatic editor to convert a lathe program into a mill program or a mill program into a lathe program. The computer aided control system 400 can therefore include controls that have the option to have conversation programming ability built in.

While particular embodiments have been disclosed, it is to be understood that various different modifications are possible and are contemplated within the true spirit and scope of the appended claims. There is no intention, therefore, of limitations to the exact abstract or disclosure herein presented.

What is claimed:

1. A method for turning an unfinished piece of material comprising:
providing a milling machine with a cutting tool spindle that rotates about an axis of rotation and a work platform that has one or more working tools, wherein the position and orientation of the work platform in relation to the position and orientation of the spindle can be changed using an automated control system;
securing the piece of material to the cutting tool spindle of the milling machine so that the material is secured along the axis of rotation of the spindle;
rotating the spindle thereby spinning the material about the axis of rotation; and
bringing one or more of the working tools into contact with the material, thereby removing a portion of the material.

2. The method of claim 1, wherein the piece of material is secured to a chuck that is secured to the spindle.

3. The method of claim 2, wherein the chuck is secured to a chuck adapter that is secured to the spindle on one end and to the chuck on another end.

4. The method of claim 1, wherein the work platform is a rectangular or square workbench comprising a linear tooling block with said one or more tools.

5. The method of claim 4, wherein the linear tooling block comprises a square or rectangular block portion and one or more tools extending horizontally from the block portion and one or more tools extending vertically from the block portion.

6. The method of claim 1, wherein the work platform is a rotary cylinder that rotates about an axis of rotation that is substantially perpendicular to the axis of rotation of the cutting tool spindle of the milling machine.

7. The method of claim 6, wherein the rotary cylinder comprises a cylindrical base and a first set of tools that extend radially outward from the base and a second set of tools that extend in a direction substantially parallel to the axis of rotation of the rotary tool cylinder.

8. The method of claim 1, wherein the cutting tool spindle rotates about a substantially vertical axis of rotation, and wherein the piece of material is secured in a vertical orientation along the axis of rotation of the spindle.

9. The method of claim 1, wherein the cutting tool spindle rotates about a substantially horizontal axis of rotation, and wherein the piece of material is secured in a vertical orientation along the axis of rotation of the spindle.

10. A milling machine system comprising:
a tooling platform adapted to be secured to a milling machine table, said tooling platform comprising one or more tools extending horizontally from the tooling platform and one or more tools extending vertically from the tooling platform;
a cutting tool spindle that rotates about an axis of rotation, wherein the spindle comprises a securing means adapted to secure a piece of material to be machined in an orientation along the axis of rotation of the spindle;
an automated control system comprising code for controlling operation of the milling machine to perform milling operations; and
software that converts the code for controlling operation of a milling machine to perform milling operations into code for controlling operation of a milling machine to perform one or more turning operations.

11. The system of claim 10 wherein the securing means comprises a chuck adapter and a chuck, the chuck adapter having a first end and a second end, wherein the first end has a connector adapted to connect with the spindle and the second end has a connector adapted to connect with a chuck, and wherein the chuck is configured to secure the piece of material to be machined.

12. The system of claim 10, wherein the tooling platform is rectangular.

13. The system of claim 10, wherein the tooling platform is cylindrical.

14. The system of claim 13, wherein the tooling platform is mounted on a rotary table.

15. The system of claim 10, wherein the cutting tool spindle rotates about a substantially vertical axis of rotation, and wherein said securing means is adapted to secure a piece of material in a vertical orientation along the axis of rotation of the spindle.

16. The system of claim 10, wherein the cutting tool spindle rotates about a substantially horizontal axis of rotation, and wherein said securing means is adapted to secure a piece of material in a horizontal orientation along the axis of rotation of the spindle.

17. A milling machine system comprising:
a cutting tool spindle that rotates about an axis of rotation, wherein the spindle comprises a securing means adapted to secure a piece of material to be machined in an orientation along the axis of rotation of the spindle;
a rotary tooling platform comprising a rotary cylinder that rotates about an axis of rotation that is substantially perpendicular to the axis of rotation of the cutting tool spindle of the milling machine, wherein the rotary cylinder comprises a cylindrical base and a first set of tools that extend radially outward from the base and a second set of tools that extend in a direction substantially parallel to the axis of rotation of the rotary tool cylinder;
an automated control system comprising code for controlling operation of the milling machine to perform milling operations; and
software that converts the code for controlling operation of a milling machine to perform milling operations into code for controlling operation of a milling machine to perform one or more turning operations.

18. The system of claim 17, wherein the cutting tool spindle rotates about a substantially vertical axis of rotation, and wherein said securing means is adapted to secure a piece of material in a vertical orientation along the axis of rotation of the spindle.

19. The system of claim 17, wherein the cutting tool spindle rotates about a substantially horizontal axis of rotation, and wherein said securing means is adapted,to secure a piece of material in a horizontal orientation along the axis of rotation of the spindle.

20. A machining tool comprising:
a tombstone mounting fixture that rotates about a first axis of rotation, the tombstone mounting fixture comprising a top surface; and
a rotary tooling platform comprising:
a cylindrical base that rotates about a second axis of rotation;
a first set of tools that extend radially outward from the base; and
a second set of tools that extend in a direction substantially parallel to the axis of rotation of the base, wherein the rotary tooling platform is mounted on the top surface of the tombstone mounting fixture, and wherein the second axis of rotation is substantially parallel to the first axis of rotation.

21. The machining tool of claim 20, wherein the first and second axis of rotation are substantially aligned.

22. The machining tool of claim 20, wherein the rotary tooling platform is rotatable independent from the tombstone.

23. A milling machine system comprising:
a cutting tool spindle that rotates about a first axis of rotation, wherein the spindle comprises a securing means adapted to secure a piece of material to be machined in an orientation along the axis of rotation of the spindle;
a tombstone mounting fixture that rotates about a second axis of rotation, the tombstone mounting fixture comprising a top surface;
a rotary tooling platform comprising:
a cylindrical base that rotates about a third axis of rotation;
a first set of tools that extend radially outward from the base; and
a second set of tools that extend in a direction substantially parallel to the axis of rotation of the base, wherein the rotary tooling platform is mounted on the top surface of the tombstone mounting fixture, and wherein the third axis of rotation is substantially parallel to the second axis of rotation.
an automated control system comprising code for controlling operation of the milling machine system to perform milling operations; and
software that converts the code for controlling operation of the milling machine system to perform milling operations into code for controlling operation of a milling machine to perform one or more turning operations.
